(19) United States
(12) Patent Application Publication
(10) Pub. No.: US 2008/0201302 A1
(43) Pub. Date: Aug. 21, 2008

(54) USING PROMOTION ALGORITHMS TO SUPPORT SPATIAL SEARCHES

(75) Inventors: Gur Kimchi, Bellevue, WA (US); Shahaf Abileah, Seattle, WA (US); Pusheng Zhang, Kenmore, WA (US); Nikolai M. Faaland, Seattle, WA (US); Joseph Schwartz, Redmond, WA (US); Kenn D. Cartier, Redmond, WA (US); Norman L. Bryar, Sammamish, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/675,847

(22) Filed: Feb. 16, 2007

(51) Int. Cl. G06F 17/00

(52) U.S. Cl. 707/3

(57) ABSTRACT

Computerized methods and systems for performing a search utilizing a spatial index are provided. Upon receiving a search query having a zoom level component (e.g., “Italian Restaurants in Seattle”), a search is initially conducted of the zoom level tags associated with the content items in the spatial index to determine if any of the content items include a zoom level tag indicative of the zoom level component of the search query (e.g., zoom level of city for Seattle). Subsequently, only those content items satisfying the zoom level search are grouped into a primary subset, whereby the primary subset may be filtered by selecting those returned content items with location-based tags that match a location-based component of the query (e.g., Seattle, Wash.). Next, the those content items satisfying the location-based filter are grouped into a location-based subset, which are filtered according to the parsed query components (e.g., category component Italian Restaurants).

### BACKGROUND

In data-searching systems preceding the Web, and on the Web since its inception, users have employed a variety of tools to aid in organizing and accessing data, which in turn facilitates navigating the available information. Users often employ some of these tools to search for documents matching specific criteria, e.g., retrieving documents containing specific keywords. In addition, some of these tools utilize search engine technology to present information about geographic regions. These tools are particularly useful for users that desire to execute a search that canvasses virtually all of documents accessible by the Web. Accordingly, search results may be returned in response to a wide variety of search queries being conducted by standard Web search engines.

Web navigation systems are geared toward examining an expansive field of documents available in a network and then comparing the pure-text content of each against the search query in order to provide comprehensive results. However, when performing a Web search for businesses within a particular region, the navigation system yields the same expansive search before considering the geographic limitations inherent to the query. Also, when displaying the search results, the result identifiers may overlap on a user interface map. Not only is this a needlessly time-consuming process and an uneconomical use of search-supporting equipment, it renders an ineffective presentation of the query results.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to performing searches utilizing a spatial index. A spatial index is a collection of content items, at least some of which have a zoom level tag associated therewith. Upon receiving a search query having a zoom level component (e.g., “Italian Restaurants in Seattle”), a search is initially conducted of the zoom level tags associated with the content items in the spatial index to determine if any of the content items include a zoom level tag indicative of the zoom level component of the search query (e.g., zoom level of city for Seattle). Subsequently, only those content items satisfying the zoom level search are grouped into a primary subset, whereby the primary subset may be filtered by selecting those returned content items with location-based tags that match a location-based component of the query (e.g., Seattle, Wash.). Next, those content items satisfying the location-based filter are grouped into a location-based subset, which may then experience additional filtrations to determine those content items that satisfy the remainder of the parsed query (e.g., category component Italian Restaurants).

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary computing system configured to receive a query, search a spatial index, and determine whether any of the content items in the spatial index satisfy the query, in accordance with an embodiment of the present invention;

FIG. 3 is a flow diagram showing a method for performing a search utilizing a spatial index, in accordance with an embodiment of the present invention;

FIG. 4 is a flow diagram showing a method for organizing content items into a searchable spatial index, in accordance with an embodiment of the present invention;

FIG. 5 is a flow diagram showing a method for examining content items to determine if clustering and/or filtering is required, in accordance with an embodiment of the present invention;

FIG. 6 is a flow diagram showing a method for filtering content items based upon query components, in accordance with an embodiment of the present invention;

FIG. 7 is a schematic diagram depicting a layered grid structure that may be utilized for grouping content items into cluster(s) based upon spatial proximity and maximum quantity, in accordance with an embodiment of the present invention;

FIG. 8 is an illustrative screen display of an exemplary user interface for receiving a query, in accordance with an embodiment of the present invention;

FIG. 9 is an illustrative screen display of an exemplary user interface for displaying visual indicators of content item(s) based upon relevance, in accordance with an embodiment of the present invention; and

FIG. 10 is an illustrative screen display of an exemplary user interface for displaying groups as cluster(s) based upon spatial proximity, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide computerized methods and systems, and computer readable media having computer-executable instructions embodied thereon, for performing searches utilizing a spatial index. As utilized herein, the term “spatial index” refers to a collection of content items, at least some of which have a location-based tag associated therewith. In one embodiment, the spatial index represents the content items organized in a particular fashion to facilitate efficient searching of the spatial index. In accordance with embodiments of the present invention, upon receiving a search query having a zoom level component (e.g., “Italian Restaurants in Seattle”), a search is initially conducted of the zoom level tags associated with the content items in the spatial index to determine if any of the content items includes a zoom level tag indicative of the zoom level component of the search query (e.g., zoom level of city for Seattle). Subsequently, only those content items satisfying the zoom level search are grouped into a primary subset, whereby the primary subset may be filtered by selecting those returned content items with location-based tags that match a location-based component of the query (e.g., Seattle, Wash.). Next, the content items satisfying the location-based filter are grouped into a location-based subset, which may then experience additional filtrations to determine those content items that satisfy the remainder of the parsed query (e.g., category component Italian Restaurants).

Accordingly, in one aspect, the present invention provides one or more computer-readable media having computer-executable instructions embodied thereon for performing a search utilizing a spatial index that includes a plurality of content items therein is provided, at least a portion of the plurality of content items having a zoom level tag associated therewith. A query is received, the query having a zoom level component and at least one additional component associated therewith. Subsequently, a search is performed of the spatial index using the zoom level component of the query and a primary subset of items is generated in response to the spatial index search. Next, a search is performed of the primary subset of items using the at least one additional component of the query (e.g., location-based component, category component) and it is determined whether one or more query results satisfies the query based upon the search of the primary subset of content items.

In another aspect of the present invention, a computer system is provided for performing a spatial index search in response to a query. The computer system includes a spatial index including a plurality of content items. At least a portion of the plurality of content items in the spatial index have a zoom level tag associated therewith. The computer system further includes a query receiving module, a searching module, and a display module. The query receiving module is configured to receive at least one query, the at least one query having a zoom level component and at least one additional component associated therewith. The searching module is configured to search the spatial index based upon the zoom level component of the query and to filter a subset of content items identified by the spatial index search based upon the at least one additional component of the query to determine whether one or more query results satisfies the query. The display module is configured to display at least one visual indicator representing the one of more query results on a contextual display interface.

In another aspect, the present invention provides a computerized method for organizing content items into a searchable spatial index. The method includes providing a plurality of content items, at least a portion of the plurality of content items having a zoom level tag associated therewith. The method further includes associating the zoom level tag with each of the plurality of content items having a zoom level component associated therewith, the zoom level tag representing the promotion algorithm results applied to the content item.

Further aspects of the present invention provide computer readable media having computer-executable instructions thereon for performing the methods described herein.

Having briefly described an overview of embodiments of the present invention, an exemplary operating environment suitable for implementing the present invention is described below.

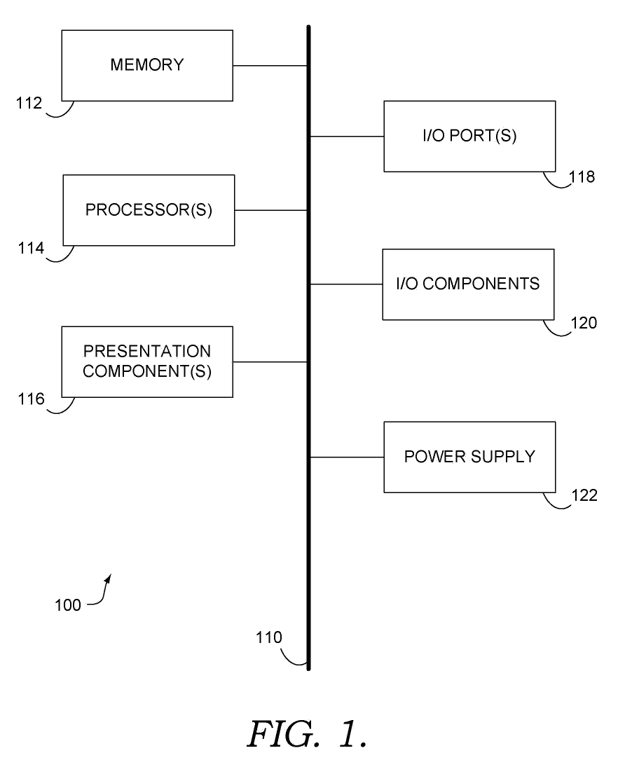

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. Embodiments of the present invention may be practiced in a variety of system configurations, including hand-held devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

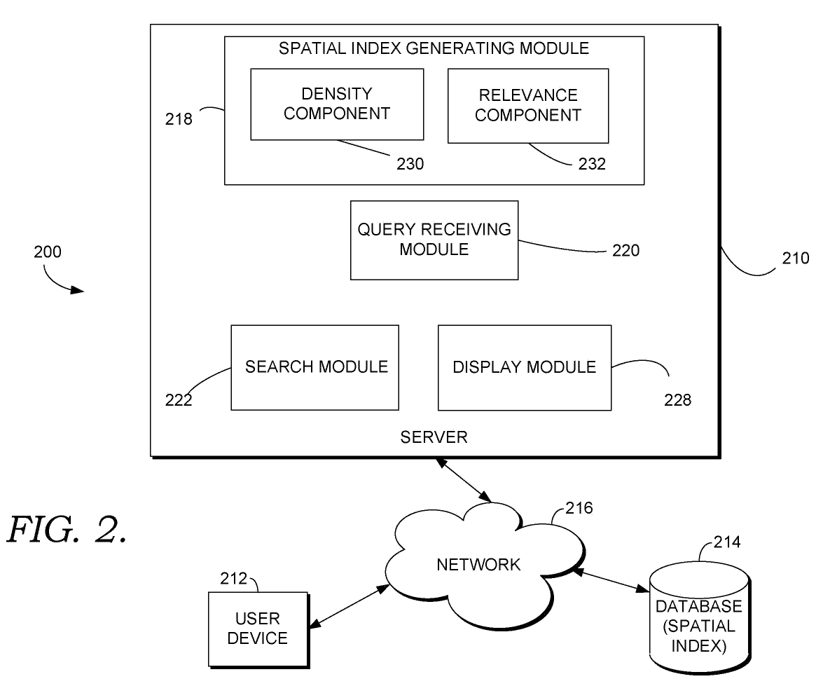

Turning now to FIG. 2, a block diagram is illustrated that shows an exemplary computing system 200 configured to receive a query, search a spatial index, and determine whether any of the content items in the spatial index satisfy the query, in accordance with an embodiment of the present invention. It will be understood and appreciated by those of ordinary skill in the art that the computing system 200 shown in FIG. 2 is merely an example of one suitable computing environment and is not intended to suggest any limitation as to the scope of use or functionality of the present invention. Neither should the computing system 200 be interpreted as having any dependency or requirement related to any single component/module or combination of components/modules illustrated therein.

Computing system 200 includes a server 210, a user device 212, and a database 214, all in communication with one another via a network 216. The network 216 may include, without limitation, one or more local area networks (LANs) and/or wide area networks (WANs). Such networking environments are commonplace in offices, enterprise-wide computer networks, intranets, and the Internet. Accordingly, the network 216 is not further described herein.

The database 214 is configured to store information associated with a spatial index. In various embodiments, such information may include, without limitation, one or more content items and one or more zoom level tags, category tags, location-based tags, relevance zoom level tags, and/or density zoom level tags associated with the content item(s). In addition, the spatial index may be void of content items such that an organizational blueprint with an empty set is retained thereby. In some embodiments, the database 214 is configured to be searchable for one or more content items and/or the tag(s) stored in association therewith. It will be understood and appreciated by those of ordinary skill in the art that the information stored in the database 214 may be configurable and may include any information relevant to a content item, i.e., an item of information. The content and volume of such information are not intended to limit the scope of embodiments of the present invention in any way. Further, though illustrated as a single, independent component, database 214 may, in fact, be a plurality of databases, for instance, a database cluster, portions of which may reside on a computing device associated with the server 210, the user device 212, another external computing device (not shown), and/or any combination thereof.

Each of the server 210 and the user device 212 shown in FIG. 2 may be any type of computing device, such as, for example, computing device 100 described above with reference to FIG. 1. By way of example only and not limitation, the server 210 and/or the user device 212 may be a personal computer, desktop computer, laptop computer, handheld device, mobile handset, consumer electronic device, and the like. It should be noted, however, that the present invention is not limited to implementation on such computing devices, but may be implemented on any of a variety of different types of computing devices within the scope of embodiments hereof.

As shown in FIG. 2, the server 210 includes a spatial index generating module 218, a query receiving module 220, a search module 222, and a display module 228. In some embodiments, one or more of the modules 218, 220, 222, and 228 may be implemented as stand-alone applications. In other embodiments, one or more of the modules 218, 220, 222, 228 may be integrated directly into the operating system of the server 210 or the user device 212, or another associated computing device (not shown). By way of example only, the search module 222 may be integrated into the operating system of the server 210, while the spatial index generating module 218 (including the density component 230 and the relevance component 232) may reside on another server (not shown) separate from the server 210. In the instance of multiple servers, a load balancer may be utilized to federate incoming queries to the servers. It will be understood by those of ordinary skill in the art that the modules 218, 220, 222, 228 illustrated in FIG. 2 are exemplary in nature and in number and should not be construed as limiting. Any number of modules may be employed to achieve the desired functionality within the scope of embodiments of the present invention.

The spatial index generating module 218 is configured to receive one or more content items, at least a portion of which have a location-based component associated therewith. In one embodiment, each of the content items is a reference to a location where information is located, such information being descriptive of, or otherwise related to, a business, an entity, a person, a location, or any other data element that may be searched in association with an index search or targeted by a query. Examples of individual reference content items include, without limitation, a reference to a document, a text-based computer file, a listing on a table, an element on an array, a computer entity that can be accessed, a character-string, a record, a text string that includes a business type, an array of events related to a business, keywords that depict characteristics of a business, and the like. In another embodiment, one or more of the individual content items may include content associated therewith, rather than merely a reference to such content. Combinations of content and references to content may also comprise content items, if desired. It will be understood and appreciated by those of ordinary skill in the art that methods for generating a spatial index are not limited to the embodiments described herein and that the nature of one or more of the content items, as well as the content included therein, may vary accordingly.

In embodiments, the spatial index generating module 218 is further configured to associate a location-based tag with each content item that includes an associated location-based component, the location-based tag representing the location-based component of the associated content item. If desired, the spatial index generating module 218 may be further configured to associate a category tag with one or more of the content items in the spatial index, as more fully described below.

The location-based tag is typically location-related metadata associated with a piece of information, e.g., content item. As such, the location-based tag identifies on a map the associated content item based upon location. In addition, if a content item does not have a location-based component, location-related content (e.g., phone number, postal address), or at least one spatial identifier, etc., then it is dropped from the spatial index. In one embodiment, the location-based tag includes a grid designation and a placement designation. In this instance, the grid designation corresponds to a grid cell—a particular area of space that is located within a grid structure. A grid structure is a pattern of grid cells that are placed with spatial reference to one another. In one embodiment, each grid cell represents an area on the surface of the Earth. In this instance, the grid cell is embodied as a 2-dimensional region defined by a set of latitude and longitude coordinates whereby the particular coordinates identify a particular grid cell. In some instances, the grid cell coordinates may identify a unique area. In other instances, one or more grid cells may over-lap with one another. In addition, a grid cell may be comprised of a plurality of other grid cells linked to other levels of detail, e.g., zoom levels, as more fully described below.

A placement designation relates to a coordinate location or a particular content item within a grid cell. In one embodiment, the placement designation is defined by specific latitude and longitude coordinates on the surface of the Earth. However, it will be understood and appreciated by those of ordinary skill in the art that multiple methods exist by which a grid cell may be defined and a content item may be located within the grid cell. As such, the grid structure may vary accordingly.

As previously mentioned, in embodiments, the spatial index generating module 218 may be further configured to associate a category tag with one or more of the content items in the spatial index. The category tag, similar to the location-based tag, is typically metadata associated with or assigned to a piece of information, e.g., content item, thus, identifying the information by one or more pre-defined categories. In one embodiment, the category tag is derived from the content included in, or referenced by, a content item through comparing the information stored in association with a content item with a pre-defined category hierarchy. By way of example only, a pre-defined category hierarchy may be determined using the Yellow Page taxonomy. If it is determined that a content item corresponds to a particular category, a category tag may be associated with that content item, wherein the associated category tag represents the particular category. In one instance, by way of example only, the content may contain the characters “restaurant” within a text string. Upon examining the content of this exemplary content item, the spatial-index generating module 218 may associate therewith a category tag of “food and dining.” Further, the category hierarchy may be expanded into sub-categories, wherein a sub-category tag may be derived from the content of a content item as well. From the instance above, by way of example only, the spatial index generating module 218 may associate a sub-category tag of “restaurants” to the content item containing “restaurant” within a text string.

The spatial index generating module 218 includes a density component 230 and a relevance component 232. The density component 230 provides a density pyramid promotion algorithm. Typically, a promotion algorithm is an index-building procedure that organizes the content items within the spatial index according to such criteria as zoom level, location (described above), category (e.g., category hierarchy), relevance (e.g., ranking algorithm), and the like. The promotion algorithm provides the advantage of an efficient organized blueprint that sorts the content items by the most selective criteria first with respect to a certain class of queries, e.g., a spatial-orientated query.

In accordance with embodiments of the present invention, content items are organized in the spatial index according to zoom level utilizing various models of the promotion algorithm. The model provided by a density component 230 is the density pyramid promotion algorithm where content items are grouped such that density information and count per criteria (e.g., category) may be provided to a user in response to a query. In addition, the density pyramid promotion algorithm appends at least one density zoom level tag to the content item(s) in the spatial index so that groups of associated content items (i.e., clusters) that reside on a particular zoom level may be recognized in response to receiving a zoom level component (described below) of a query. The zoom levels, in one embodiment, may range between 1 and 19, where zoom level 1 may depict an area that encompasses the whole world and zoom level 19 may depict an area inside a city block. It this embodiment, as the zoom level moves from high (e.g., zoom level 1) to low (e.g., zoom level 19), the area captured by the grid cells linked thereto (as described hereinabove with reference to the spatial index generating module 218) relates to a smaller portion of the surface of the Earth, but level of detail depicted therein increases.

Alternative embodiments of zoom level include level-of-detail indicators and/or promotion techniques that apply to two-dimensional searches generally. As such, spatial indexing, as considered in the present invention, comprises associating zoom levels with content items, not limited to geographical content, to facilitate structured storage within, and searching of, indices. Embodiments of indices that may be supported by zoom levels will be apparent to those of ordinary skill in the art to which the present invention pertains.

Returning to the density pyramid promotion algorithm, a density zoom level tag is assigned to one or more content items based upon the location-related metadata associated with a piece of information, e.g., content item. The process of assigning involves determining the proximity between the content items within a zoom level. In one instance, the grid designation and a placement designation (described above with reference to the location-based tag) associated with the piece of information are utilized. By way of example only, the placement designation of the content items within a grid cell, as determined by the grid cell designation, may be used to produce the proximity of the content items to each other. In a second example, only those content items of corresponding category tags are examined by the density pyramid promotion algorithm and, as such, the content items are sorted to provide a manageable set for the proximity evaluation.

Assigning a density zoom level tag also involves receiving an allocated capacity of a zoom level, or grid cell included therein, and creating groups based thereon. The allocated capacity of a grid cell is a pre-defined maximum number of content items that may be permitted to reside within the one or more grid cells of a zoom level. In one instance, the allocated capacity is based on a storage considerations. In a second instance, allocated capacity is based upon a maximum number of visual indicators (described below with reference to display module 228) that may be displayed at a user interface without creating overlapping. By way of example only, if a grid cell is slated to include restaurants in a rural region, then a grid cell linked to a higher zoom level (e.g., city level) may satisfy the allocated capacity. Alternatively, if a grid cell is slated to include restaurants within a populous metropolitan region, then a grid cell linked to a lower zoom level (e.g., street level) may satisfy the allocated capacity. In general, it can be seen that grid cells that satisfy the allocated capacity for a particular query (e.g., bottom-level grid cells) are typically linked to lower zoom levels and exhibit high levels of detail.

Next, the allocated capacity is compared to the plurality of content items on a particular zoom level. Typically, the content items are sorted a priori into groups that share a certain criteria, e.g., a grid cell or category. In one embodiment, the information in the spatial index is processed with a bottom-up approach, wherein the content items of the lowest zoom levels are processed initially. If the number of content items is less than the allocated capacity, then all items are promoted to a higher zoom level. If, however, the number of content items at a zoom level are greater than the allocated capacity, then the two most proximate content items are combined into a group or cluster. As the density pyramid promotion algorithm continues to compare, items and clusters, or clusters and clusters may be combined as well. In addition, those content items that overlap, i.e., share similar placement designations, may be combined in order to avoid confusion when displayed at the user interface. Accordingly, those content items that are not promoted but combined are assigned a density zoom level tag that is associated with zoom level immediately below (higher level of detail). Further, those clusters that are not promoted but combined with other clusters/content items are assigned a density zoom level tag that indicates the range of levels where it exists. As such, the density zoom level tag denotes the highest zoom level of promotion as determined by the density pyramid promotion algorithm, and the upper end (highest) of the range of zoom levels at which the content item or cluster is found upon searching by the zoom level component of the query.

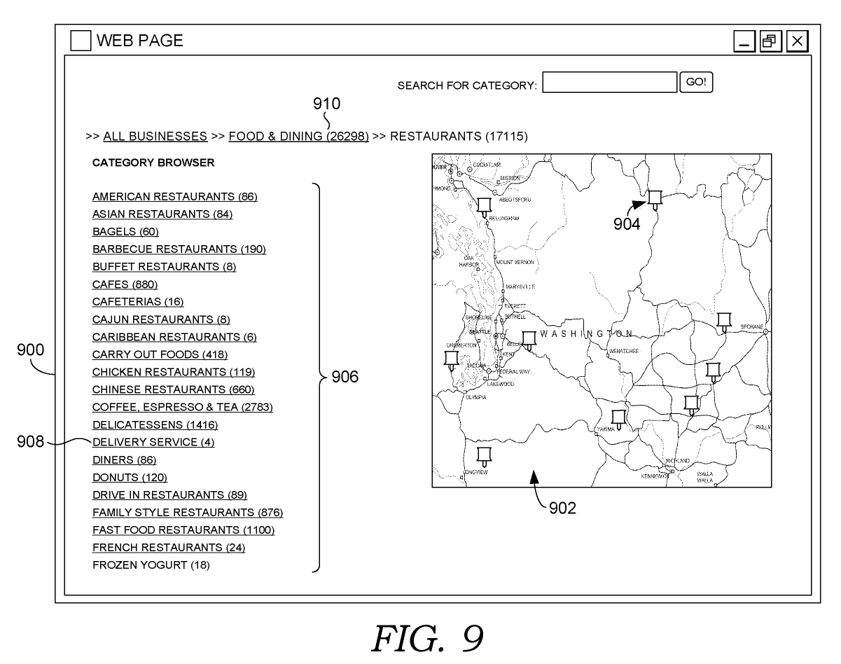

As can be understood and appreciated by those of ordinary skill in the art, the advantage of clusters is that they can serve a variety of purposes. In one instance, clusters may be utilized by the display module 228 (discussed below) to provide a visual depiction of the density of results within a selected area, e.g., topographical display. In a second instance, clusters provide a pre-calculated number of content items within a designated area, or “count” as shown in FIG. 9, reference numerals 906, 908, and 910. As such, an exemplary count represents all content items grouped into a particular cluster and permits efficient tracking of search result populations when moving between zoom levels. This configuration is faster and more efficient than the typical method of continually re-counting content items individually upon receiving a modified a search parameter.

The model provided by the relevance component 232 is a relevance pyramid promotion algorithm that typically utilizes metadata associated with or assigned to a piece of information, e.g., content item, and, accordingly, identifies a level of relevance as compared to other similarly-tagged content items. The relevance pyramid promotion algorithm executes a thinning function, which is typically performed offline prior to a search of the spatial index. Thinning provides the advantage of discovering and displaying highly relevant information upon conducting a search, and/or selecting a set of top rated items while hiding all others.

The relevance pyramid promotion algorithm promotes thinning content items, which are displayed per zoom level, to those most relevant to the query. Thinning is facilitated by assigning and appending a relevance zoom level tag thereto. The process of assigning involves identifying a level of relevance for each content item; typically, in relation to other content items of the same zoom level with similar category tags appended thereto. In one instance, the level of relevance is based upon an aggregation comprising customer reviews, reports, company contributions, and the like, which is stored as the content of the content item(s). Subsequently, the aggregation is compiled to determine a particular level of relevance for the content item, wherein compiling entails applying a ranking function, within the relevance pyramid promotion algorithm, to the aggregation such that a specific level of relevance may be calculated therefrom.

The process of appending involves comparing the allocated capacity (described above) to the content item(s) on a particular zoom level. Typically, the content items are sorted a priori into groups that share a certain criteria, e.g., a grid cell or category. If the number of content items exceed the allocated capacity then the content item associated with the lowest level of relevance is excluded from tagging and the balance of the content items are counted and compared again. If the content items of a shared criteria, at a zoom level and within a category, are fewer than the allocated capacity, then those content items remaining are appended with relevance zoom level tag. As such, each content item has typically one relevance zoom level tag appended thereto that relates to each associated criteria (e.g., category tag). Thus, a compact index is created as each content item is stored in association with only one zoom level for each criteria, as opposed to information concerning one content item residing on each zoom level for each criteria associated therewith.

Identifying and appending a relevance zoom level tag to content items allows the network 216—utilizing a keyword component of a query—to efficiently find those individual content items that reside on the zoom level(s). For instance, submitting a query with a particular zoom level component for a particular type of business will first trigger a search for relevance zoom level tags corresponding to the zoom level, typically the most selective component of a spatial query. Thus, this method of organizing and searching enables rapid navigation and discovery of content items associated with a high relevance. In addition, a plurality of relevance zoom level tags may be assigned to a particular content item if a relevance zoom level is assigned per category associated with the content item. For instance, a business may be listed both as an Italian restaurant and a bar, but may have a higher rating (potentially corresponding to a higher zoom level depending on the amount of other items in that particular category at that particular zoom level) in one category and a lower rating in another.

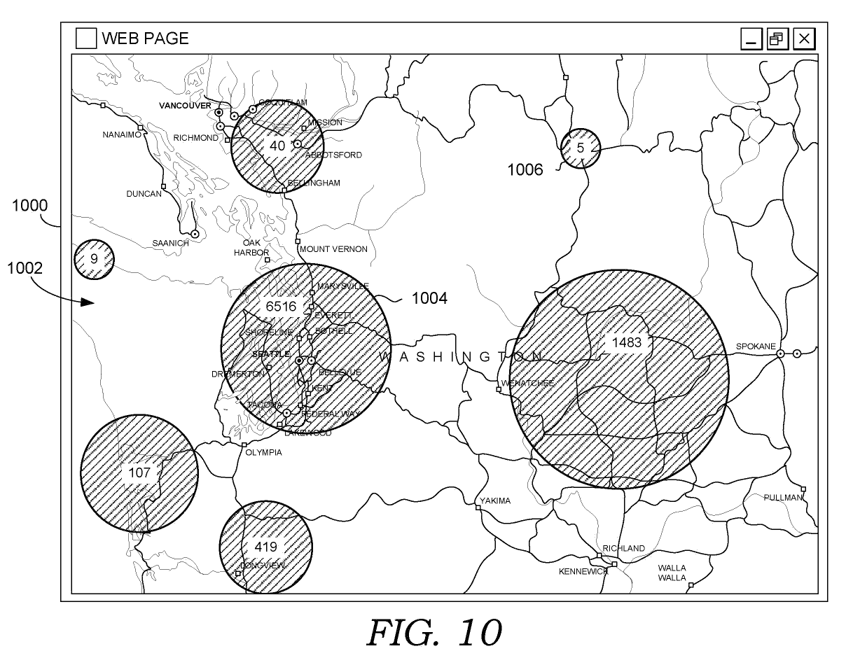

The query receiving module 220 is configured to receive a query, the query having a zoom level component, and at least one additional component, e.g., keyword component, location-based component or category component, associated therewith. As more fully described below with reference to FIG. 10, a query may be input by a user at a user interface associated with a computing device, e.g., user device 212 of FIG. 2. It will be understood and appreciated by those of ordinary skill in the art that multiple methods exist by which a user may input a query including, but not limited to, a keyboard, joystick, trackball, or the like. The query may subsequently be utilized to perform a search of a spatial index, as more fully described below.

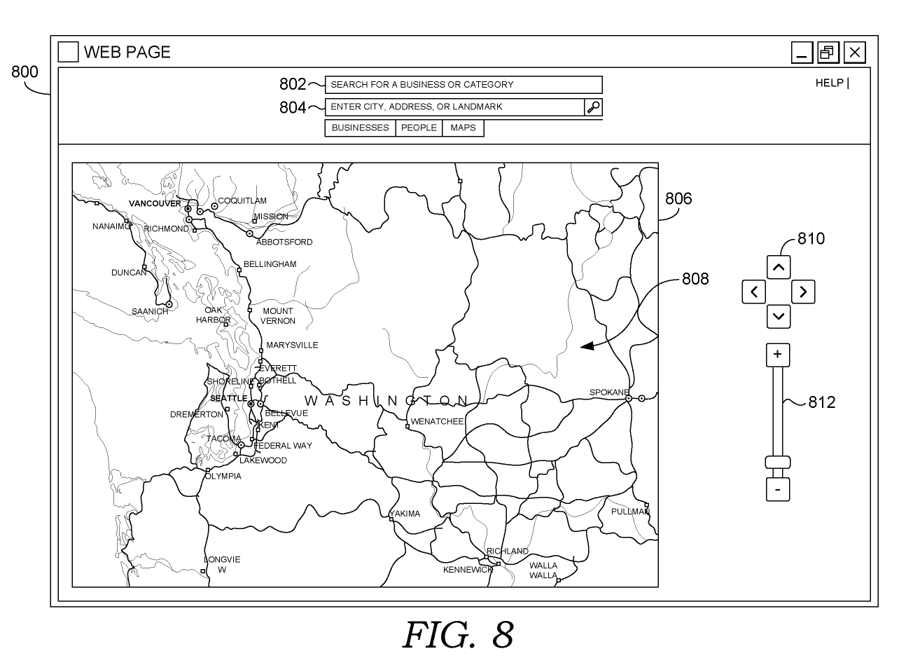

Typically, the query receiving module 220 parses the query into components that may be utilized to search the spatial index. One exemplary component is a zoom level component that is typically derived from the captured domain or text-based search query input by the user (as more fully described below with reference to FIG. 8 at reference numeral 808). Another exemplary component is the location-based component. The location-based component relates to spatially orientated criteria of the query, such as city name, postal address, landmark, or map interface, which is typically input at the user interface as a text string or as a captured domain, e.g., as shown in FIG. 8 at reference numerals 804 and 808, respectively, and more fully described below. Still another exemplary component is a keyword component. A keyword component relates to non-spatially orientated criteria of the query, such as business name, which is typically input at the user interface as a text string, e.g., as shown in FIG. 8 at reference 802 and more fully described below. Yet another component is the category component that can be entered manually or selected from a listing at the user interface (see, e.g., FIG. 9 at reference numeral 906) which relates to the category hierarchy as described above. By way of example only, the category component is limited to a finite number of business types, e.g., Yellow Page taxonomy, such that the promotion algorithm models can organize, within a pyramid, each content item in the spatial index prior to conducting a search of the spatial index.

The search module 222 is configured to perform a primary search according to the zoom level component, as more fully described below. The search module 222 compares the parsed zoom level component of the query with the zoom level tag(s) of the content item(s). As more fully described above, there may be more the one model of promotion algorithm and therefore more than one type of zoom level tag—associated with a separate pyramid structures within the spatial index—appended to a content item, and each zoom level tag may be recognized by the search module 222. The determination of which zoom level tag the primary search will recover depends upon the other components of the parsed query. In one instance, a keyword component that describes a type of business (e.g., “pizza in Remond”) may initiate the search module 222 to return a primary subset of content item(s) based upon relevance zoom level tags. In another instance, a category component selected from the category hierarchy (e.g., “food and dining”) may cause the search module 222 to conduct its primary search for density zoom level tags.

Next, the search module 222 may filter the primary subsets with any other components received in the query (as described hereinabove). Typically, the primary subset is filtered by comparing the location-based component of the parsed query with the location-based tag(s) of the content item(s) stored in association with the spatial index, e.g., in database 214. If it is determined that one or more content items having location-based tags associated therewith matches the location-based component of the query, a location-based subset of the primary subset of content items is returned. The search module 222 is further configured to search the location-based subset of content items for any additional parsed components (e.g., keyword component or category component) to determine whether any content items stored in association with the spatial index satisfies the query.

Utilizing the search module 222 that is configured to search zoom level tags first, a tailored search is executed whereby a primary subset of zoom level content item(s) is initially identified and then filtered, typically, whereby a filtered subset of location-based content items is then identified based upon the location-based component of a query. As such, the identified subsets are filtered with respect to additional query components, wherein filtering is based upon the tags described hereinabove (e.g., location-based). A spatially focused search conducted in this manner as applied to broad queries, improves the performance, e.g., efficiency and cost, of the search when finding relevant search results. In other embodiments, the search module 222 may be further configured to filter the primary subset based upon additional criteria, e.g., category tags, if desired. In one embodiment, filtering the subsets is typically initiated by the search module 222 if the search module 222 recognizes that the query includes an keyword component (e.g., what is the best restaurant in X) or any other component beyond the zoom level component.

The display module 228 is configured to display at least one visual indicator representing the one or more query results on a contextual display interface, e.g., a map, at a user interface, as more fully described below with reference to FIGS. 8-10. The user interface generally includes a domain display area. The domain display area is typically a geometric-shaped window, e.g., polygon; however, the domain display area may be configured as any contoured region. By way of example only, if a query is directed toward a route within a map, the domain display area may be configured to resemble an elongated oval in order to encompass the roads being traveled in addition to a buffer area. The domain is a graphical representation of a spatial area. Typically, the spatial area is any multi-dimensional space depicting a geographic region, section of the surface of the Earth, buildings within a city, and the like. In addition, a captured domain (see, e.g., FIG. 8 at reference numeral 808) is the portion of the domain selected by the user as the spatial area limits of the query (e.g., location-based component or zoom level component) and is typically indicated at the domain display area. However, the boundaries of the domain display area and the limits of the captured domain do not necessarily co-extensive (e.g., the captured domain may be portion of the domain display area). When executing a search at the user interface, the domain display area is utilized by the display module 228 to present the user with a graphical representation of the search results. It will be understood and appreciated by those of ordinary skill in the art that methods for presenting a domain are not limited to the embodiments described herein and that user interfaces may vary accordingly.

In some instances, content items discovered by a search of the spatial index and returned as search results may be displayed at a user interface by visual indicators. Visual indicators represent content items and may be viewed at the user interface of a computing device. Typically, the promotion algorithm models organize the partial index such that the number of content items returned from a search, which are displayed as visual indicators, is no more that can be easily interpreted by a user. Visual indicators typically represent the location of content items returned in the search results within the captured domain. Visual indicators, or “markers”, provide the user with an approximate location of a content item-or clusters as described hereinabove-and may sometimes be displayed as an icon, a pictogram, a symbol, alphanumeric character(s), bitmapped graphics, or the like. In one embodiment, if the query results include a plurality of content items along a particular street, the marker may be configured as a thick line. In another embodiment, if the query results include a dense cluster of content items of close spatial proximity, the marker may be configured as a geometric shape that represents the cluster. It will be understood and appreciated by those of ordinary skill in the art that methods for presenting visual indicators of content items to a user are not limited to the embodiments described herein and that markers may vary accordingly.

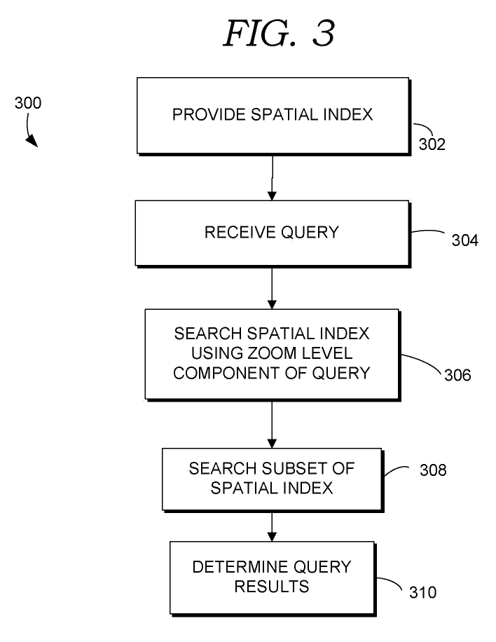

Turning now to FIG. 3, a flow diagram is illustrated that shows a method 300 for performing a search utilizing a spatial index, in accordance with an embodiment of the present invention. Initially, as indicated at block 302, a spatial index is provided and a query is received, e.g., utilizing query receiving module 220 of FIG. 2, as indicated at block 304. The received query includes a zoom level component and at least one additional component, e.g., a keyword component and/or location-based component. The query is parsed into its constituent components and a spatial index is subsequently searched using the zoom level component of the query, as indicated at block 306, e.g., utilizing search module 222 of FIG. 2. As a result, a primary subset of content items is generated. Subsequently, as indicated at block 308, the primary subset of content items is searched, e.g., utilizing search module 222 of FIG. 2, based upon the at least one additional component of the query. It is then determined whether one or more query results satisfies the query based upon the search of the zoom level subset of content items, as indicated at block 310.

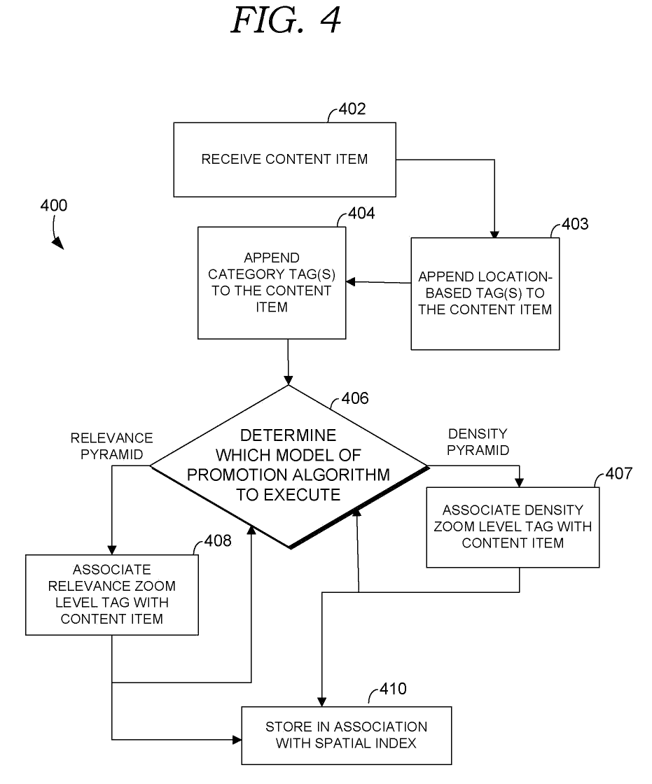

With reference to FIG. 4, a flow diagram is illustrated that shows a method 400 for organizing content items into a searchable spatial index, e.g., utilizing spatial index generating module 218, in accordance with an embodiment of the present invention. As indicated at block 402, a content item is initially received, the content item having a location-based component associated therewith. Subsequently, as indicated at block 403, a location-based tag is associated with the content item. Next, the content item is examined to determine if it corresponds to a category and/or subcategory within the category hierarchy. If a corresponding category is identified, a category tag representing that category is associated with the content item, as indicated at block 404.

Subsequently, it is determined which promotion algorithm model(s) to execute, the promotion algorithm being configured to determine zoom levels of relevance and/or density based on the criteria of content item(s) relative to the criteria of other content items as disclosed above with reference to spatial index generating module 218 (see, e.g., ranking function, grid cell, category, etc.). This is indicated at block 406. Upon performing the appropriate promotion algorithm(s) the content items are appended with a zoom level tag that is associated with the density pyramid (407) and/or relevance pyramid (408) structures within the spatial index. It is contemplated within embodiments of the present invention that a content item may be appended with a one or a plurality of zoom level tags and any order by which the promotion algorithms are performed will support building the spatial index (e.g., utilizing the spatial index generating module 218). Next, the content item is stored in association with the spatial index, as indicated at block 410.

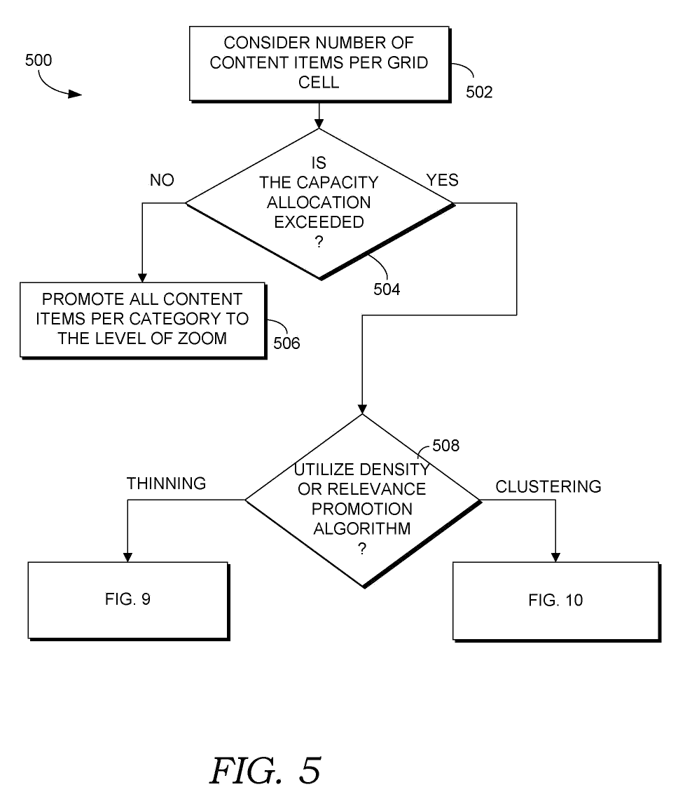

With reference to FIG. 5, a flow diagram is illustrated that shows a method 500 for examining content items to determine if performing a thinning or clustering operation in accordance with a promotion algorithm is required, in accordance with an embodiment of the present invention. Initially, as indicated at block 502, content items are examined to determine if the number of content items exceeds the capacity allocation associated with the level of zoom, category, and/or grid cell. If it is determined that the number of content items does not exceed the capacity allocation (decision is indicated at block 504), then all content items within a particular grid cell and with corresponding category tags are promoted to the present level of zoom. This is indicated at block 506. If, however, it is determined that the number of content items does exceed the capacity allocation, it is determined whether clustering or thinning of the results is necessary. This is indicated at block 508. It will be understood by those of ordinary skill in the art that, at times, both clustering and thinning will be required and/or desired. Embodiments of the present invention contemplate clustering and thinning of query results individually or in any desired combination.

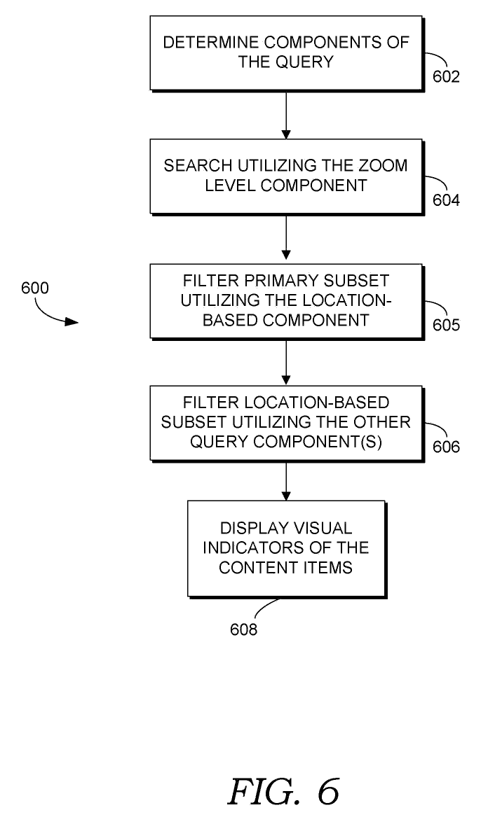

Turning now to FIG. 6, a flow diagram illustrating a method 600 for searching for query results based upon zoom level tag(s) and filtering the primary subset, e.g., utilizing search module 222 of FIG. 2, in accordance with an embodiment of the present invention is shown and designated generally as reference numeral 600. Initially, as indicated at block 602, a query is parsed into specific components, e.g., utilizing query receiving module 220 of FIG. 2. The search is then conducted, whereby the initial examination of the spatial index utilizes the zoom level component. This is indicated at block 604. Next, the initial examination, employing the zoom level component, produces a primary subset that is filtered utilizing the location-based component, as indicated at block 605. This secondary search typically produces a narrower set of content items that is returned in the location-based subset, wherein the location-based subset may be filtered with any other components that are parsed from the original query, as indicated at block 608. The final filtration of a subset produces the search results that are delivered to the display module 228. Then the content items in the search results may be displayed as visual indicators at the user interface, as indicated at block 608.

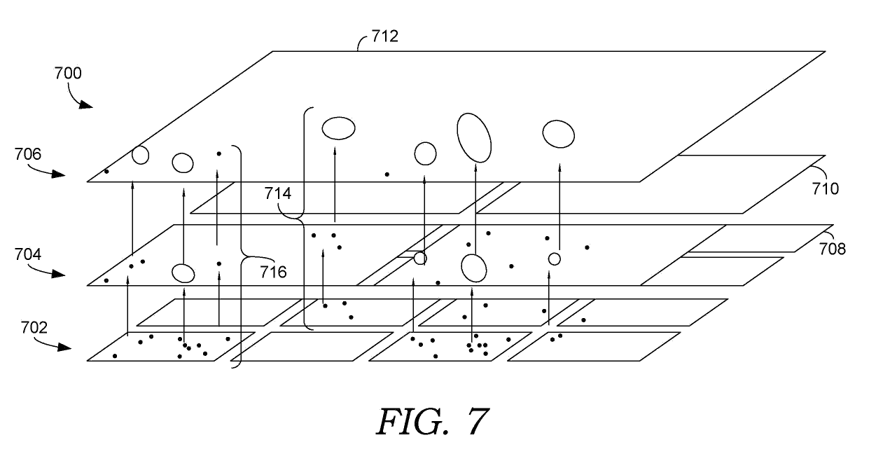

With reference to FIG. 7, a schematic diagram depicting a layered grid structure 700 that may be utilized for grouping content items into cluster(s) based upon spatial proximity, in accordance with an embodiment of the present invention, is shown. The grid structures 708, 710, and 712 are associated with various zoom levels 702, 704, and 706, respectively. In addition, the grid structures 708, 710, and 712 include grid cells therein. The grid structure 708 is associated with zoom level 702, a low zoom level, e.g., street level, as described more fully above. The grid structures 710 and 712, associated with zoom levels 704 and 706, respectively, typically represent higher zoom levels, e.g., city level and state level respectively.

In one embodiment, the lowest zoom level may be associated with the zoom level component of the query (e.g., captured domain) and, as such, the content items and clusters are presented to the user as visual indicators based upon the density zoom level tags appended thereto. As can be seen, the grid cells of the higher zoom levels have a lower level of detail, but encompass a larger portion of the domain. Additionally, grid cells of low zoom levels, e.g., zoom level 702, are aggregated to form the grid cells of higher zoom levels, e.g., zoom level 704. Accordingly, content items are aggregated within the low zoom level grid cells when promoting the results to higher zoom level grid cells if required based upon the capacity allocation.

By way of example only, a density pyramid promotion algorithm 714 is depicted as promoting three content items from zoom level 702 to zoom level 706. As can be seen, the three content items are promoted separately from the zoom level 702 to the zoom level 704. This promotion embodiment is based upon (a) the population of similarly categorized content items within the grid cell being promoted, e.g. utilizing the grid designation, (b) whether the content items overlap, e.g., utilizing the placement designation, and (c) the spatial proximity of the three content items. As shown in FIG. 7, the three content items are aggregated into a cluster when promoted to zoom level 706. In this instant promotion, the quantity of content items in the grid cell was greater than the allocated capacity for the particular zoom level 706. As such, the spatial proximity of the content items to be promoted is analyzed and those of close spatial proximity, e.g., the three content items of density pyramid promotion algorithm 714, are aggregated to satisfy the capacity allocation.

Alternatively, density pyramid promotion algorithm 716 depicts a single entity being promoted from zoom level 702 to the highest zoom level 706, individually and without being aggregated. In this instance, although aggregation is required to satisfy the allocated capacity of zoom level 702, it is determined that the distant spatial proximity of the single content item in density pyramid promotion algorithm 716 to other content items does not require aggregating the single content item. As such, a visual indicator representing the single content item may be displayed on the domain display area. In one instance, content items with greater spatial proximity, e.g., rural businesses, will be displayed individually, while content items with close spatial proximity, e.g., businesses in a large city, will be aggregated and displayed as a cluster. One advantage to the user is a clear indication of where a concentration of content items occurs and how the search results are distributed.

In another instance, the rural businesses may be filtered, e.g., utilizing the search module 222 of FIG. 2 to filter the primary subset, if they are not relevant or do not provide value in association with the user's query. Accordingly, the individual content items may be removed from the search results and only the largest clusters will be displayed. The advantage to the user is a more relevant search that displays a wider selection of content items.

Turning now to FIG. 8, an exemplary screen display is shown illustrating an exemplary user interface 800, e.g., a contextual display interface, for receiving a query, in accordance with an embodiment of the present invention. User interface 800 includes a first search area 802 and a second search area 804 for receiving search queries. A user may input a query into search areas 802 and 804. The user is promoted to enter a “business or category” query into the first search area 802, which is typically parsed into the keyword component of the query. Additionally, the user is promoted to enter a “city, address, or landmark” query to second search area 804, which is typically parsed into the zoom level and/or location-based component of the query. Also, the user is allowed to select and area of the domain, i.e., captured domain 808, within or at a portion of the domain display area 806, which is typically associated with the zoom level and/or location-based component of the query. Tools are provided to assist the user in selecting the captured area.

In the embodiment depicted in FIG. 8, a domain scrolling tool 810 and a zoom level tool 812 are depicted. The domain scrolling tool 810 is configured to shift the coordinates associated with longitude and latitude of the domain being displayed at the domain display area 806. The zoom level tool 812 is configured to move zoom levels from high to low, or vice-versa, such that the user can select a captured domain with the desired level of detail from within or focused within the domain display area 806. It will be appreciated and understood by those skilled in the art that methods for selecting a domain are not limited to the embodiments described herein and that the tools provided at the user interface may vary accordingly.

As can be understood and appreciated by those of ordinary skill in the art, any domain selected by the user as the captured domain will produce a rapid search, e.g., utilizing the search module 212, regardless of the size of the domain area to be searched. This is due to the zoom level structures of the spatial index as configured by the promotion algorithm(s). For instance, if a high level of zoom is searched (large area of the domain captured) then the visual indicators representing content item(s) are few because they have been sorted and thinned by the promotion algorithm a priori. Conversely, if a low zoom level is searched (small area of domain captured) then there naturally exists a limited number of content items having a location-based component that corresponds to the captured area. As such, in this second instance, an efficient search is conducted even when the promotion algorithm(s) have performed minimal thinning of the content items.

Turning now to FIG. 9, an illustrative screen display depicting an exemplary user interface 900, e.g., a contextual display interface, for reducing visual indicators of content items based on the relevance pyramid promotion algorithm, in accordance with an embodiment of the present invention is shown. A domain display area 902 is configured to display visual indicators, wherein each visual indicator 904, e.g., pushpin, relates to a content item that is most relevant, e.g., utilizing the relevance component 232 of the spatial index generating module 218 of FIG. 2. That is, the relevance pyramid promotion algorithm has thinned out the content items associated with the lowest level of relevance and retained a number of content items that satisfies the allocated capacity per the ranking function. As such, the visual indicators both indicate relevant content items and are distributed in a comprehensible manner on the captured domain 902.

Additionally, a list of categories 906 related to the keyword component and/or category component of the query are presented on user interface 900. An individual category 908, in this instance, represents a sub-category within the category hierarchy. The individual category 908 also includes a number of content items returned in the query results that relate to a subcategory represented by the individual category 908. Additionally, displayed on the user interface 900 is an expanded category depiction 910. The expanded category depiction 910 displays the main category associated with the query and the narrower subcategories that assist in focusing the search. Again, because the visual indicators on the captured domain 902 represent a selection of the content items promoted by the relevance pyramid promotion algorithm, the categories and narrower subcategories in the expanded category depiction 910 may include a count of content items, e.g., utilizing the clusters as created by the promotion algorithms of the spatial index generating module 218, returned in the search results that relate to the respective category/subcategory of the query but were not displayed on the user interface.

Turning now to FIG. 10, an illustrative screen display depicting an exemplary user interface 1000, e.g., a contextual display interface, for reducing visual indicators based upon spatial proximity is shown, in accordance with an embodiment of the present invention. Visual indicators 1002 and 1004 represent clusters of content items aggregated by the density pyramid promotion algorithm, more fully described above with reference to FIG. 2 and spatial index generating module 218 of FIG. 2. As shown, the visual indicators 1002 and 1004 are circles wherein the size of the circle corresponds to a quantity of content items represented thereby. It will be appreciated and understood by those skilled in the art that visual indicators representing content items and/or clusters may be depicted in a variety of manners, and may or may not, correspond to the content items being represented. Additionally, the user is presented with a number of content items contained within each visual indicator 1002 and 1004, to assist with locating the particular concentrations of content items in the query results.

As can be understood, embodiments of the present invention provide computerized methods and systems, and computer readable media having computer-executable instructions embodied thereon, for performing searches utilizing a spatial index. In accordance with embodiments of the present invention, upon receiving a search query having a zoom level component (e.g., “Italian Restaurants in Seattle”), a search is initially conducted of the zoom level tags associated with the content items in the spatial index to determine if any of the content items include a zoom level tag indicative of the zoom level component of the search query (e.g., zoom level of city for Seattle). Subsequently, only those content items satisfying the zoom level search are grouped into a primary subset, whereby the primary subset may be filtered by selecting those returned content items with location-based tags that match a location-based component of the query (e.g., Seattle, Wash.). Next, those content items satisfying the location-based filter are grouped into a location-based subset, which may then experience additional filtrations to determine those content items that satisfy the remainder of the parsed query (e.g., category component Italian Restaurants).

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-readable media having computer-executable instructions embodied thereon for performing a search utilizing a spatial index including a plurality of content items, at least a portion of the plurality of content items having a zoom level tag associated therewith, the method comprising:
receiving a query, the query having a zoom level component and at least one additional component associated therewith;
searching the spatial index using the zoom level component of the query to generate a primary subset of content items;
searching the primary subset of content items using the at least one additional component of the query; and
determining whether one or more query results satisfies the query based on the search of the primary subset of content items.

2. The one or more computer-readable media of claim 1, wherein searching the spatial index using the zoom level component of the query comprises searching the zoom level tags associated with the plurality of content items in the spatial index to generate the primary subset of content items, and wherein each content item comprising the primary subset of content items includes a tag indicative of the zoom level component of the query associated therewith.

3. The one or more computer-readable media of claim 1, wherein if it is determined that one or more of the plurality of content items satisfies the query, the method further comprises displaying at least one visual indicator representing the one or more of the plurality of content items on a contextual display interface.

4. The one or more computer-readable media of claim 3, wherein the contextual display interface includes a map.

5. The one or more computer-readable media of claim 3, wherein the contextual display interface is configured to display a plurality of zoom levels, and wherein the visual indicator is configured to vary based upon the zoom level displayed.

6. The one or more computer-readable media of claim 5, wherein the method further comprises organizing the one or more of the plurality of content items into at least one level, wherein the at least one level corresponds to one of the plurality of zoom levels that the contextual display interface is configured to display.

7. The one or more computer-readable media of claim 6, wherein organizing the one or more query results into at least one level comprises:
grouping at least a portion of the one or more of the plurality of content items that satisfies the query into at least one cluster, wherein the at least one visual indicator represents the at least one cluster of the plurality of content items; and
determining a quantity of clusters based upon a pre-defined maximum number of visual indicators that may be displayed in association with the at least one zoom level.

8. The one or more computer-readable media of claim 7, wherein grouping at least a portion of the one or more of the plurality of content items into at least one cluster comprises grouping at least a portion of the one or more of the plurality of content items based upon spatial proximity.

9. The one or more computer-readable media of claim 1, wherein the method further comprises thinning the one or more of the plurality of content items based upon relevance.

10. The one or more computer-readable media of claim 1, wherein one or more of the plurality of content items in the spatial index includes a location-based tag associated therewith.

11. The one or more computer-readable media of claim 10, wherein the method further comprises determining a location associated with the at least one additional query component, wherein searching the primary subset of content items comprises searching the location-based tags associated the content items in the primary subset of content items using the at least one additional query component to generate a location-based subset of content items, and wherein determining whether one or more query results satisfies the query comprises determining whether one or more of the content items in the primary subset of content items includes a tag indicative of the location associated with the at least one additional query component.

12. The one or more computer-readable media of claim 1, wherein one or more of the plurality of content items in the spatial index includes a category tag associated therewith.

13. The one or more computer-readable media of claim 11, wherein the method further comprises determining a category associated with the at least one additional query component, wherein searching the location-based subset of content items comprises searching the category tags associated the content items in the location-based subset of content items using the at least one additional query component, and wherein determining whether one or more query results satisfies the query comprises determining whether one or more of the content items in the location-based subset of content items includes a tag indicative of the category associated with the at least one additional query component.

14. A computer system for performing a spatial index search in response to a query, the system comprising:
a spatial index including a plurality of content items, each of the plurality of content items having a zoom level tag associated therewith;
a query receiving module configured to receive at least one query, the at least one query having a zoom level component and at least one additional component associated therewith; and
a search module configured to search the spatial index based upon the zoom level component of the query and configured to search a subset of content items identified from the spatial index search to determine whether one or more query results satisfies the query.

15. The computer system of claim 12, further comprising a display module configured to display at least one visual indicator representing the one or more query results on a contextual display interface.

16. The computer system of claim 13, further comprising a spatial index generating module configured to organize the one or more query results into at least one level, wherein the at least one level corresponds to a level of detail that the contextual display interface is configured to display.

17. The computer system of claim 13, wherein the spatial index generating module includes a density component configured to group at least a portion of the plurality of content items into at least one cluster, the at least one visual indicator representing a cluster of query results, and a relevance component configured to determine a plurality of content items to display based upon a pre-defined maximum number of visual indicators that may be displayed in association with the at least one level.

18. A computerized method for organizing content items into a searchable spatial index, the method comprising:
providing a plurality of content items, at least a portion of the plurality of content items having a zoom level component associated therewith; and
associating a zoom level tag with each of the plurality of content items having a zoom level component associated therewith, the zoom level tag representing the zoom level component of the associated content item.

19. The computerized method of claim 18, wherein upon receiving a request to search the spatial index, it is determined if any of the zoom level tags associated with the plurality of content items satisfies the search request.

20. The computerized method of claim 18, wherein if it is determined that one or more of the zoom level tags associated with the plurality of content items satisfies the search request, it is subsequently determined if the content item associated with each of the zoom level tags satisfying the search request also satisfies the search request.
